(19) United States
(12) Patent Application Publication
(10) Pub. No.: US 2004/0253346 A1
(43) Pub. Date: Dec. 16, 2004

(54) Liquid filled, wafer covered, edible communion cup

(76) Inventor: John Amato, Burleson, TX (US)

Correspondence Address: Richard C. Litman, LITMAN LAW OFFICES, LTD., P.O. Box 15035, Arlington, VA, 22215, US

(21) Appl. No.: 10/461,410

(22) Filed: Jun. 16, 2003

(51) Int. Cl. A23L 1/00

(52) U.S. Cl. 426/89

(57) ABSTRACT

An edible cup, drink and a wafer cover prepackaged for sacrament services. The edible cup may be made from carbohydrates and coated with an edible wax for containing a sacramental liquid, which may be wine, juice or distilled water. In use the communion wafer is removed and consumed with the liquid to satisfy the requirements of the sacrament. The cup may also be consumed to avoid waste.

### BACKGROUND OF THE INVENTION

1. Field of the Invention

The present invention relates generally to an edible Communion cup. More specifically, the invention is an edible Communion cup containing a juice, wine or water substitute, and which is sealed with a wafer cover, the package being particularly useful for the delivery of communion in religious services.

2. Description of the Related Art

The relevant art of interest describes various drinking cups, but none discloses the present invention. There is a need to supply an edible sacramental cup containing the Communion liquid (wine, or a juice or water substitute) with the wafer sealing the liquid in the Communion cup for religious ceremonies. It would speed up the Communion ceremony and save on time spent on disposing the normal used cups in the ceremony. The related art will be discussed in the order of perceived relevance to the present invention.

German Patent Application No. DE 40 21 805 A1 published on Jan. 16, 1992, describes a drinking vessel of consumable material based on carbohydrates, such as a communion wafer material, for hygienic use in religious services. The drinking vessel is distinguishable for not requiring a religious wafer covering a filled liquid in the cup which is packaged for later use.

Broadman & Holman Supplies published an advertisement titled “Remembrance, INDIVIDUAL COMMUNION WAFER AND JUICE SETS”, of unknown publication date. The advertisement describes a communion cup made of plastic, filled with juice and covered by a double seal of a plastic seal over a communion wafer. The cups require no refrigeration. The purity seal is distinguishable for requiring a covering seal over the communion wafer, and the cup is inedible.

U.S. Pat. No. 3,290,154 issued on Dec. 6, 1966, to Wesley Turner describes an edible cup made from either bread or cake batter. The cup is distinguishable for lacking an edible cover.

U.S. Pat. No. 4,603,051 issued on Jul. 29, 1986, to Irving H. Rubenstein et al. describes an edible cone or cup coated internally with commercially available fat compositions containing a filler material such as starches, dextrins, food grade talc, titanium dioxide, silica, and calcium phosphates, and containing flavors such as rye, onion, garlic, orange, lemon, grapefruit, grape, banana or maple. The cup is distinguishable for lacking a cover with a similar composition.

U.S. Pat. No. 6,423,357 issued on Jul. 23, 2002, to Raymond Woods et al. describes an edible cup made of dehydrated fruit or dehydrated vegetable material. FIG. 4 describes a lid having a hole for a straw and a living hinge to the cup. The lidded cup is distinguishable for requiring a hole in the lid with a hinge, and cannot hold liquids for shipping.

European Patent Office Patent Application No. EP 0 752 209 A1 published on Jan. 8, 1997, describes the production of containers, beakers, cups, etc., made of edible or feed material which is biologically degradable. Starch dough is baked by a heatable baking mould in three steps. The containers are distinguishable for lacking covers and being used as feed for animals.

U.S. Pat. No. 5,284,672 issued on Feb. 8, 1994, to Sadaharu Ito describes a method of producing edible containers in the form of a cone, cup or dish in which soft ice cream is placed. The waffle cone is porous, lightweight and has a crispy texture. The cone is distinguishable for its required different structure, porosity, being lidless, and cannot hold a liquid for shipping.

U.S. Pat. No. 5,916,611 issued on Jun. 29, 1999, to Burt J. Bell describes an edible ice cream or yogurt container shaped with parallel concave and convex sides made of conventional ice cream cone materials such as wheat flour, sugar, oil, and water. The topless container is frozen with the ice cream or yogurt. The product is distinguishable for requiring a specific shape, no cover, frozen food, and therefore holds no liquid for shipping.

U.S. Pat. No. 6,068,866 issued on May 30, 2000, to Francesca Petrini et al. describes an edible cup made of twice-baked pastry having an impermeable layer consisting essentially of sugar, water, starch, and gum arabic. The cup can contain hot or cold drinks without leaking. The cup is distinguishable for requiring two bakings and an inner coating composition containing gum Arabic, has lacks a lid.

U.S. Pat. No. 4,205,091 issued on May 27, 1980, to William J. Van Horne describes an edible server comprising an elongated wafer formed with a series of cup-shaped receptacles made by baking a flour based batter containing shortening and coconut oil. The edible server is distinguishable for requiring a connected cup server and lacking a wafer cover.

U.S. Pat. No. 3,410,691 issued on Nov. 12, 1968, to Mary E. Stanley describes an edible cone made of a yeast-raised bread dough having a thick wall. The cone may be filled with food such as cooked meat, relish, chopped onions, cole slaw, with or without a topping. The cone is distinguishable for requiring a filling of food, having a different structure, and cannot hold any liquid contents by lacking a wafer cover.

Japan Patent Application No. 7-59507 published on Mar. 7, 1995, describes a method for readily producing an inverted conical edible cup made of wheat flour. The cup is distinguishable for its conical structure and lacking a wafer cover.

PCT Patent Application No. WO/20604 published on Jul. 11, 1996, describes a method for making an edible eating or drinking utensil such as a straw, chop-stick, stirrer or cup. An edible straw is made from a kneaded composition of 40% flour, 36% water, 12% soy protein, 4% edible fibers, 4% egg powder, 1.2% hydrocolloids, 1.2% dehydrated albumin, 1% dextrose and saccharin mixture, 0.6% lecithin, and flavoring and coloring. The cup is distinguishable for lacking a wafer cover.

None of the above inventions and patents, taken either singly or in combination, is seen to describe the instant invention as claimed. Thus, a liquid-filled, wafer-covered, edible Communion cup solving the aforementioned problems is desired.

### SUMMARY OF THE INVENTION

The present invention is directed to an edible Communion cup containing either juice, wine or water, and covered with a Communion wafer. The benefits of packaging the sacramental cup and wafer for religious ceremonies are numerous. The prepared composition does not require refrigeration. There is no clean up or need to prepare the cup with liquid and to distribute the wafer.

Accordingly, it is a principal object of the invention to provide an edible Communion cup.

It is another object of the invention to prepare an edible Communion cup having a Communion wafer as a cover.

It is a further object of the invention to prepare an edible Communion cup containing juice, wine or water.

Still another object of the invention is to prepare an edible communion cup prefilled with liquid and covered with a communion wafer for worldwide distribution.

It is an object of the invention to provide improved Communion elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a liquid-filled, wafer-covered, edible Communion cup according to the present invention.

FIG. 2 is a perspective view of a liquid-filled, wafer covered, edible Communion cup according to the present invention partially opened with the liquid inside shown in shadow.

Similar reference characters denote corresponding features consistently throughout the attached drawings.

### DETAILED DESCRIPTION OF THE PREFERRED EMBODIMENT

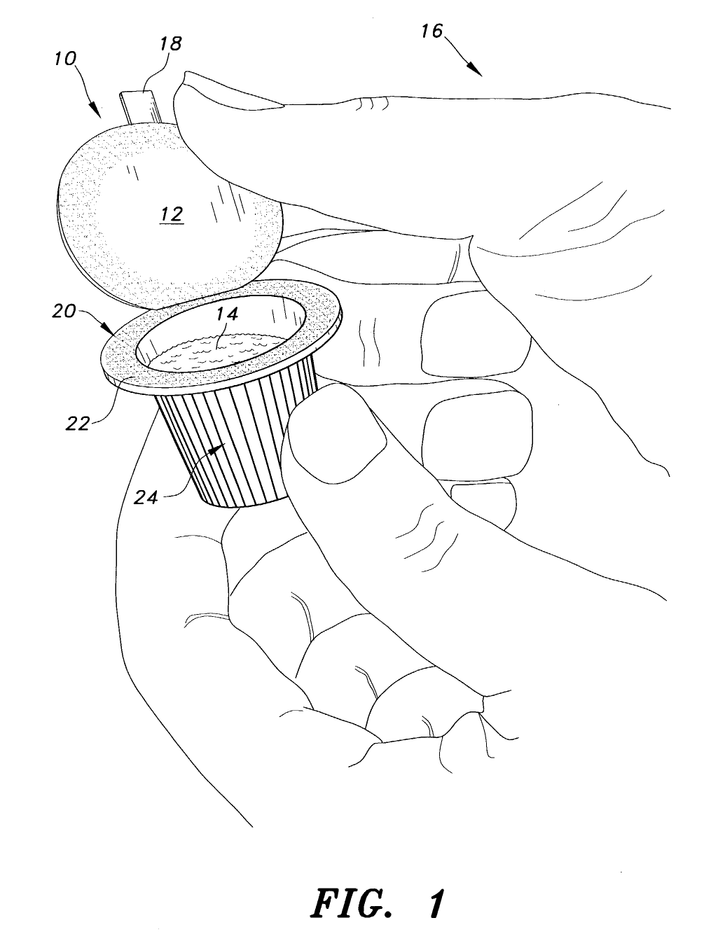

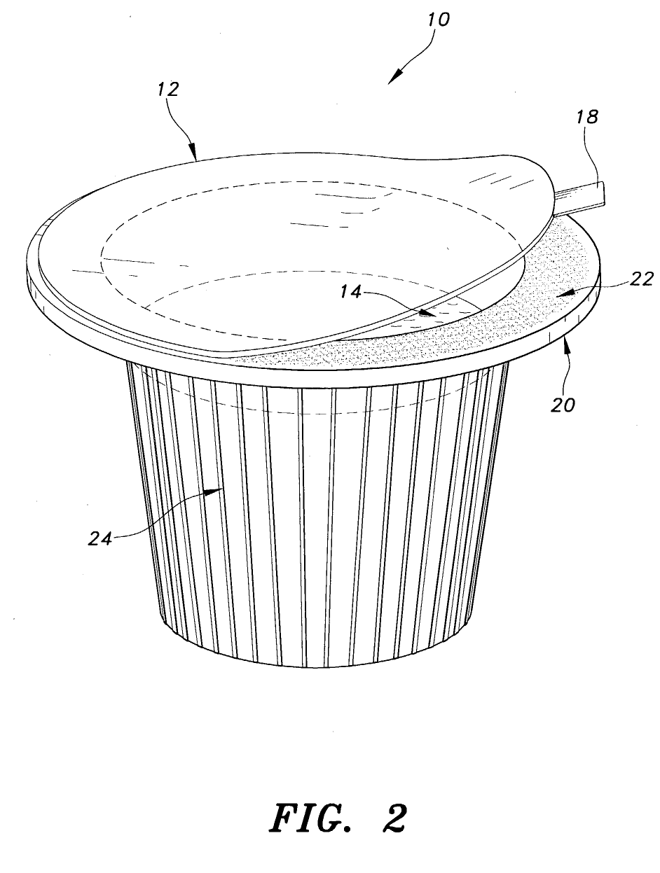

In FIGS. 1 and 2, the present invention is directed to a packaged communion cup 10 having a communion wafer 12 as a cover for the communion liquid 14 inside. In FIG. 1, the parishioner 16 has opened the cup 10 by lifting the tab 18. The cup 10 has a wide peripheral lip 20 coated with an edible adhesive 22 to provide adequate closure security and a corrugated or ribbed sidewall 24 for providing additional structural stability to the cup.

The edible food composition of the cup 10 and the wafer 12 can constitute initially approximately 70 weight percent of either wheat gluten, wheat flour, barley flour, oats flour, rice flour, corn zein, soy protein, or soy flour, or mixtures thereof and baking powder, with the balance constituting glycerol and the like solvent and plasticizer, distilled water, and vegetable oil, and the like. A sweetening agent such as sugar, saccharin, aspartame or vanilla extract or mixture thereof can be added. A flavoring agent such as vanilla, grape, lemon, peach, orange, strawberry, chocolate, and mixtures thereof can be added in a suitable amount.

A preferred composition consists of the following ingredients in their preferred amounts by weight: 5 parts wheat flour, 2 parts wheat gluten, 3 parts glycerol, and 2% baking powder.

The cup 10 and wafer 12 are baked separately at conventional temperatures. The cup 10 is formed in baking cup pans having corrugated cup sides. The wafer 12 should be flexible in order to peel off the cup 10 without fracturing. More vegetable oil can be added to the wafer composition prior to baking.

The inner surfaces of the cup 10 and wafer 12 are coated with an edible lipid, such as paraffin wax, cheese wax, beeswax, carnauba wax, and mixtures thereof, in order to prevent the contained liquid from damaging the cup 10 and wafer 12 during storage. It is also contemplated that the outer surfaces of the cup 10 and wafer 12 can be wax-coated.

The communion liquid 14 may be wine, or if permitted by religious protocol, juice or water.

It is to be understood that the present invention is not limited to the embodiment described above, but encompasses any and all embodiments within the scope of the following claims.

I claim:

1. A liquid filled, wafer covered, edible Communion cup, comprising:
an edible cup having an open mouth;
a liquid composition contained in said cup; and
an edible wafer sealed over the mouth of the cup in order to form a removable cover to contain the liquid;
whereby, the wafer and liquid composition can be consumed to fulfill Communion requirements, and the cup can be consumed to avoid waste.

2. The Communion cup according to claim 1, wherein the edible cup and wafer are made of about 70 weight percent, before baking, of ingredients selected from the group consisting of wheat gluten, wheat flour, barley flour, oats flour, rice flour, corn zein, soy protein, soy flour, and mixtures thereof, and baking powder.

3. The Communion cup according to claim 2, wherein the edible cup and wafer are made of about 30 weight percent, before baking, of a plasticizer selected from the group consisting of glycerol, vegetable oil, and mixtures thereof, and sufficient distilled water to form a batter.

4. The Communion cup according to claim 1, wherein the edible cup has a corrugated sidewall.

5. The Communion cup according to claim 1, wherein the edible wafer has a tab extending from the cup

6. The Communion cup according to claim 1, wherein the inner surfaces of the cup and wafer have a coating of an edible lipid selected from the group consisting of paraffin wax, beeswax, cheese wax carnauba wax, and mixtures thereof.

7. The Communion cup according to claim 6, wherein the outer surfaces of the cup and wafer have a coating of an edible lipid selected from the group consisting of paraffin wax, cheese wax beeswax, carnauba wax, and mixtures thereof.

8. The Communion cup according to claim 1, further comprising a sweetening agent added to the cup and wafer composition selected from the group consisting of sugar, saccharin, aspartame, and mixtures thereof.

9. The Communion cup according to claim 1, wherein the contained liquid composition is selected from the group consisting of juice, wine and distilled water.

10. The Communion cup according to claim 1, wherein the cup further comprises a wide peripheral lip defining the mouth for attachment of the wafer.

11. The Communion cup according to claim 1, further comprising a flavoring agent including a flavoring agent added to the cup and wafer composition selected from the group consisting of vanilla, grape, lemon, peach, orange, strawberry, and chocolate.

12. The Communion cup according to claim 1, wherein the Communion cup consists of in parts weight: 5 parts wheat flour, 2 parts wheat gluten, 3 parts glycerol, and 2%.
